(19) United States
(12) Patent Application Publication
(10) Pub. No.: US 2012/0166311 A1
(43) Pub. Date: Jun. 28, 2012

(54) DEFERRED PAYMENT AND SELECTIVE FUNDING AND PAYMENTS

(75) Inventors: John Dwight, Santa Clara, CA (US); Gregory Lisiewski, Forest Hill, CA (US); Michael Wu, Mountain View, CA (US); Thomas Whitford, Newark, DE (US); Parijat Sinha, San Jose, CA (US); Darrell Esch, San Jose, CA (US); Carolyn Groobey, Annapolis, MD (US); Brian Biglin, Lutherville, MD (US); Sanjeev Kriplani, Mountian View, CA (US); Sofya Pogreb, Palo Alto, CA (US); Gregg Zigler, San Jose, CA (US)

(73) Assignee: EBAY, INC., San Jose, CA (US)

(21) Appl. No.: 13/336,929

(22) Filed: Dec. 23, 2011

Related U.S. Application Data
(60) Provisional application No. 61/427,062, filed on Dec. 23, 2010.

(51) Int. Cl. G06Q 30/06

(52) U.S. Cl. 705/26.43; 705/26.41

(57) ABSTRACT

A user is able to change one or more payment options after payment has already been made to a merchant. A payment provider processes a payment request during a transaction with the merchant with default or selected payment options. After the transaction with the merchant is completed and the merchant has been paid, the user may change one or more of the payment options, such as funding source(s) and terms/conditions of payment (e.g., deferment period, installment period/amount, etc.). During the transaction, the user may make a purchase through the payment provider even if the user does not have an account with the payment provider by providing user information, such as name, address, phone number, email address, and date of birth, but not a social security number or funding source information.

### CROSS REFERENCE TO RELATED APPLICATION

The present application is related to and claims priority to U.S. Provisional Patent Appl. Ser. No. 61/427,062, filed Dec. 23, 2010, which is incorporated by reference in its entirety.

### BACKGROUND

1. Technical Field

The present invention generally relates to electronic payments, and in particular, to user selectable payment options.

2. Related Art

Shopping online or electronically is becoming more and more prevalent. This is due in part to the ease of which a consumer can find, pay, and complete a transaction without going to a seller's physical location. Such online shopping is predominantly done from a consumer's PC or laptop, but also from the consumer's mobile device, and as such, payment providers have developed payment products that enable the consumer to quickly, easily, and safely make an electronic payment for a purchase.

However, typical payment products do not give the consumer much flexibility regarding payment terms and conditions. For example, today's bank payments immediately debit a user's bank account. Today's credit card payments allow a user to aggregate and “defer” the transfer of money from their bank account but there are very strict and inflexible terms, fees, and payment schedules.

Consumers, although, have widely different incomes and different financial situations, and thus, may not wish to be bound by today's payment conditions. As a result, the consumer may decide not to make a certain purchase or postpone it (and possibly eventually forget or forego the purchase altogether). This leads to lost sales for the merchant, as well as the consumer missing out on a desired purchase.

In addition, typical credit products require the consumer to provide sensitive information, such as a social security number, which the credit provider uses to determine whether to extend credit and for what amount. The consumer's information is submitted to a credit bureau to determine credit-worthiness. This can be disadvantageous if a consumer does not want to provide such information, resulting in no credit issued and lost sales. Additionally, even if the consumer decides to provide the information, reports to credit bureaus may reduce the consumer's credit score.

It would be advantageous to have a method in which a consumer can create and choose specific payment conditions best suited for the consumer at any given time without the disadvantages discussed above.

### SUMMARY

Embodiments of the present disclosure provide the user has the ability to choose a type of payment (funding source, delayed payment, installments, instant, revolving credit, etc.) and control funding and deferments, including choosing a schedule for payment, at the time of payment.

In another embodiment, the user has the ability to change payment options after the purchase on a transactional level, e.g., initial purchase made offline, online, or on the user's mobile device, and then change payment/funding options online or other means.

In another embodiment, the user has the ability to choose a funding source after purchase. If the initial funding source is X and the payment request is approved with X, the user may still be able to change the funding source to Y after the purchase has been completed. This can be advantageous if the user later decides that Y is a better funding source, e.g., if Y later offers a promotion for use.

In other embodiments, deferred debit is provided to enable users to pay with debit but with the added flexibility and control to schedule (within a reasonable amount of time) when the debit is initiated, an evergreen/revolving credit for a traditional revolving line of credit with no maturity date is provided, and installments with revolving credit but with the added flexibility and control to define payment schedules is provided.

In one embodiment, the consumer has the ability to make a purchase and put the purchase on the consumer's “tab” so that the consumer can settle the account later, where a payment provider provides the credit to make the purchase with a limited amount of information from the user and without the need for the consumer's social security number or funding source information. In one embodiment, the consumer or user provides name, address, email, phone number, and date of birth. The payment provider uses this information internally (without a third party credit bureau) to determine whether to provide credit to the user. The determination can be made with processes similar to Bill Me Later, an eBay company. In another embodiment, the user can define a period of payment within certain limits. In one embodiment, a phone number may not be needed if the request is made through the user's mobile device. In that case, the payment provider may be able to obtain information about the mobile device, such as device ID or phone number, from the request for making the credit determination.

Thus, a consumer can get credit to make a purchase with limited information supplied to the credit issuer (e.g., no SSN or funding source information) and without the need of a credit bureau or other credit agency. The consumer is also provided flexibility in determining conditions and terms for funding and payments, both before and after a transaction is completed.

Thus, user is provided a suite of different payment options that will allow a user to have enhanced flexibility and control over when and how they pay for products or services, online and offline. Providing users with enhanced flexibility and control of when and how they pay for their transactions will only empower them with new payment options that can meet their unique transactional and servicing needs.

The payment provider can provide this experience both online and offline which would include, but not limited to, mobile, physical card, POS, Virtual Terminal, etc., in all transactional flows (e.g., checkout, send money, invoicing, etc.) and throughout the account and transaction management experience. By integrating this service across the transactional and shopping experience, the payment provider can target users based on the merchant category, AOV and user profile. For example, a user who is looking at buying a computer monitor for $300 could see this option on the merchant's homepage and product item page to spread the payments across three months for a small service fee. Users will be able to determine which payment options, the suite of payment term/condition options or existing/traditional funding instruments (e.g. bank, balance or credit cards), are most appropriate for each of their transactions. Giving users the flexibility and control to determine when, how much and with which funding instrument to pay off their outstanding financial transactions will provide users with dramatically more control and flexibility relative to traditional bank and credit card payments.

There are many benefits for both consumers and merchants. Consumer benefits include, but are not limited to 1) Enhanced flexibility and control of when and how payments are made (i.e. cash flow management) that go beyond traditional bank and credit card payments; 2) Additional value propositions that are not offered by existing payment options. Value may range from cheaper payment options (e.g., lower fees and penalties) to added payment protection policies to additional control over cash flow management; 3) Increased value and engagement with the payment provider account as such deferred payment options could only be made available and offered to payment provider account holders; 4) Complementary payment options, as the deferred payment options will complement existing payment options in a user's account. Users have the option to choose a deferred payment option or “pay now” either at the time of the payment request or at a later date; 5) Reduced checkout friction by eliminating the requirement to decide and choose a specific “pay now” or other funding/payment option at the time of checkout; and 6) Reduced friction points for existing payment provider policies (e.g. sending limits, verification requirements) since users can decide to push payments to the payment provider to settle a deferred payment transaction.

Merchant benefits include, but are not limited to 1) Providing merchant customers with “increased” buying power via financing options, additional protections, flexible payment schedules, etc. for both debit and credit payments; 2) Minimal loss/risk to the merchant as the deferred payment options are offered and managed by the payment provider; 3) Increased checkout conversion; 4) Increased average order value; and 5) Increased value proposition for merchants.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 is a flowchart showing one embodiment of a process a user performs in making a financial transaction through a payment provider, where the user or consumer may change one or more of the payment types or options during or after a checkout;

FIG. 2A is a flowchart showing one embodiment of a process a payment provider performs to process a payment request for a user;

FIG. 2B is a flowchart showing one embodiment of a process a payment provider performs to process a change to a previously approved payment request after the purchase has been made;

FIG. 3 is a block diagram of a networked system suitable for implementing the processes described herein according to an embodiment; and

FIG. 4 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to different embodiments, a consumer or user may select a type of payment, payment terms, or be given credit without the consumer having to submit a social security number, before checkout, at the time of payment, and be able to change any of the selections after payment. Examples for payment options (before, at, or after purchase) may include holding off payment until a certain period after the transaction, at which time, payment is automatically debited from a consumer funding source, such as a bank, on or by a specific day, paying in installments determined by the consumer, paying the amount within a grace period, payment using one or more funding sources (e.g., credit card(s), bank, stored balance, gift card, debit card, coupons, etc.) selected by the user, etc. This gives the consumer more flexibility to make a payment using terms or products best suited for the consumer, both at the time of payment and after if desired.

Table 1 shows different non-limiting examples of funding sources and payment options selectable by the user before, during, or after checkout. These can be combined as applicable. Note that payment type, payment option, payment terms, payment conditions, and other payment selections may be referred to collectively as “payment options” as used herein.

TABLE 1

| Payment Type | Payment Option |
|---|---|
| American Express | Standard Terms of Payment Type |
| Visa | Instant Settlement (Full) |
| Discover | Instant Settlement (Partial) |
| MasterCard | Delayed Debit Payment |
| Bank Card | Installments |
| Checking Account | Grace Period Before Payment(s) |
| Savings Account | Split Payment Types |
| Gift Card | Consolidate Payment Types |
| Store Credit Card | |
| “Fast Credit” | |
| Cash | |
| Check | |
| Coupon | |
| Store Balance | |
| Payment Provider Account | |

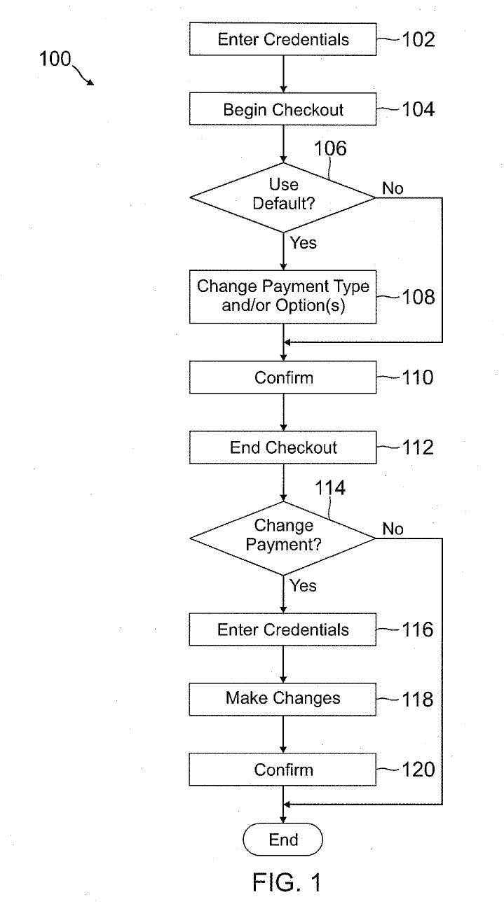

FIG. 1 is a flowchart showing one embodiment of a process 100 a user performs in making a financial transaction through a payment provider, where the user or consumer may change one or more of the payment types or options in Table 1. At step 102, the user enters user credentials, such as through a user device like a smart phone, tablet, PC, laptop, etc. The user may access the payment provider through a browser or mobile App/browser. The user may also access the payment provider through a merchant or payee device, such as at a POS. User information entered may include a user identifier (user name, phone number, or email address), a device ID, and/or a login credential, such as a password or PIN.

At step 104, the user begins a check process. Note that steps 102 and 104 can be performed in reverse order or at the same time. Checkout can be online, such as on a merchant site, or offline, such as at point of sale (POS) of a brick-and-mortar location. A checkout process may begin when the user is ready to make a payment, such as for services, goods, donations, and the like. For an online checkout, the user may select a “checkout” button or link from a merchant site through the user's device. For an offline checkout, the user may select a suitable button or link on the user device or a merchant device, present the merchant with a payment instrument or user identifier, present the merchant with goods to scan, or any other means.

After a total is obtained from the checkout process, the user may be given an option of using a default set of payment settings. This may occur before or during checkout as well. For example, the user may see that default payment is through a payment provider account, a user account with the merchant, or through the user's Visa account.

The user then makes a determination, at step 106, whether to use the default payment options. One reason the user may decide to not use the default options is that the user is saving for a trip and trying to earn as many points as possible through another credit card, such as American Express.

If the user wishes to change one or more default payment options, the user may enter the desired changes at step 108. Changes may include changing one or more payment types or payment options, including splitting the payment between a plurality of payment types and/or changing a payment option for one or more payment types. The changes can be made in any suitable manner. For example, the user may select desired changes from drop down menus from the appropriate box or field on a payment screen. The drop down menu may include allowable changes for the particular field. The user may also manually enter requested information, such as a funding source account number, a change in payment date or installments.

Once changes are made, if desired by the user, the user confirms the payment selection (either default or revised) at step 110. The user may be presented with details of the payment selection and requested to either confirm to revise, such as going back to a previous screen to revise. Once the user confirms, such as by selecting a “confirm,” “purchase,” “pay,” or other similar link or button, the payment request is processed by the payment provider.

The payment provider may then notify the user and/or the merchant whether the payment has been made or approved. If approved, a notification may be received with a message indicating the payment was made and a transaction identifier associated with the payment. The user then ends the checkout process at step 112.

After the checkout process is ended, the user may decide at some point to change the payment selections made during the checkout, at step 114. The user may only be able to change payment selections for a certain time period, where the time period may vary depending on the type of payment change. The user changing one or more payment selections may be the result of various changed circumstances. For example, the user ma have decided initially to defer payments for 60 days because of money issues. However, since the purchase, the user has more disposable income than expected, so the user may desire to make an earlier payment to avoid paying interest or other fees incurred for a 60 day deferral period.

If the user is contemplating or has decided on making one or more changes, as determined by the user at step 114, the user may access the user's account with the payment provider, such as by entering login credentials (e.g., user ID and password/PIN), at step 116. This may be through a user device, such as a smart phone, tablet, PC, or other computing device, and need not be the same device the user used previously to make the payment.

Once the user has accessed the user's account, the user may make the desired change(s) at step 118. For example, the user may be presented with an option to make changes to one or more payment transactions. The user may then select the desired payment transaction, and available changes may be shown to the user. For example, if the user selected a deferred payment date with installment payments, the user may have the option of paying the full amount now, with one or more funding sources, paying a partial amount now, with one or more funding sources, split the payment over multiple funding sources, increase or decrease the deferral date, and/or change the amount or period of the installment payments.

Once the desired changes are made, the user may confirm the changes at step 120. The user may be shown the current changes, along with any relevant information related to the changes, such as time to complete payment, savings or additional costs due to the changes, etc. If the user wishes to revise any changes, such as the user not correctly specifying a desired change, the user may make the necessary changes before confirming. Note that steps 114-120 may be performed by the user any time after the checkout has ended, as allowed by the payment provider.

After confirmation, the payment provider may process the changes, such as managing any credits and debits to specific accounts, setting time periods for credits and debits, and anything else associated with processing the payment selections for the user.

Consequently, the user is given the flexibility to subsequently change one or more payment options made at the time of payment. This may be beneficial to the user if a situation or condition changes after the initial payment. This may also result in a purchase that the user may otherwise not have made. For example, the user may not be sure how to make a payment for the purchase, and due to the uncertainty and not wanting to be locked into a final decision, the user may choose a payment option with knowledge that that option can be changed later if needed or desired.

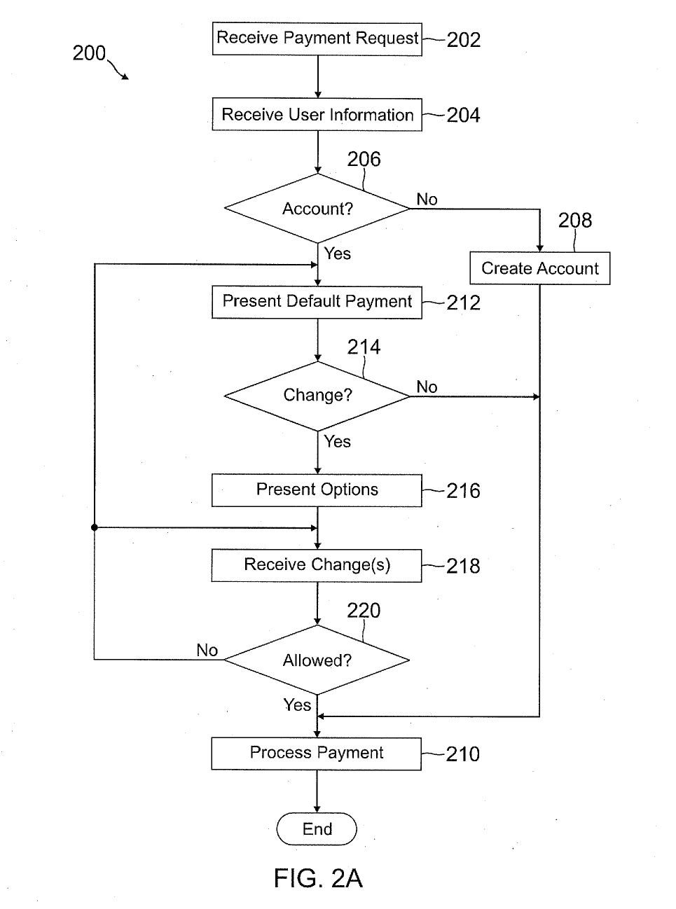

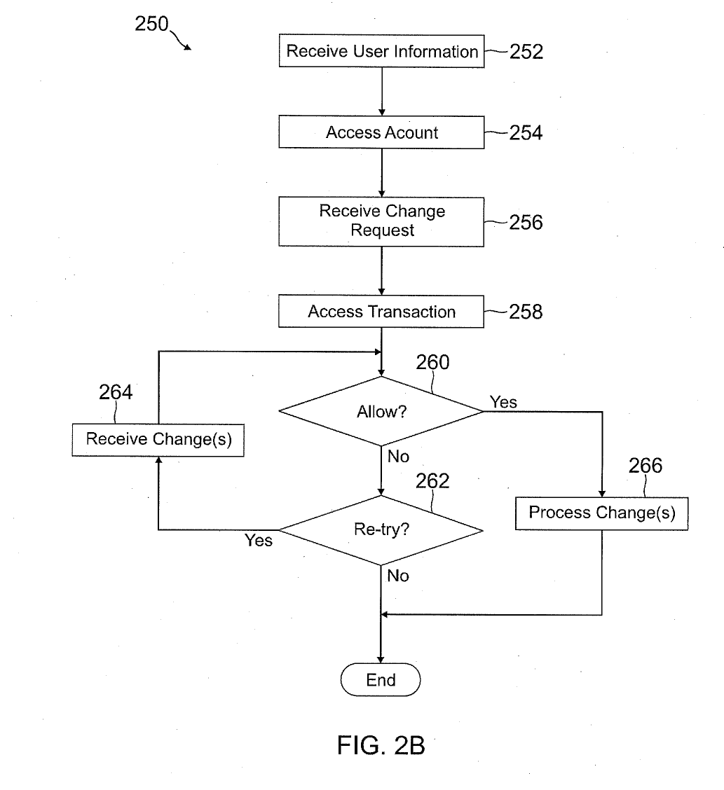

FIG. 2A is a flowchart showing one embodiment of a process 200 a payment provider performs to process a payment request for a user. At step 202, the payment provider receives a payment request from the user, such as through a user device. The payment request may be received, by a server of the payment provider, through a merchant or seller site/App when the user is ready to make a payment, such as a purchase transaction with the merchant.

At step 204, the payment provider receives user information, which may include a user identifier, such as a user name, name, email address, phone number, IP address, or device ID. If the user has an account with the payment provider, the information may also include a password or PIN associated with the user account. The information may be included with the payment request in step 202 or separately before or after step 202.

Based on the received information, the payment provider determines, at step 206, whether the user has an account with the payment provider. For example, the payment provider may search an account database to see if received user information corresponds to an active account. If no active account exists, the payment provider may request the user to create an account, such as providing a password/PIN, address, date of birth, email address, phone number, information about a funding source, etc. Upon receipt of the requested information, the payment provider processes the information, such as determining credit worthiness, including information about the funding source, which typically is a credit card or bank account. After processing/analysis, a user account may be created at step 208, which will allow the user to make payments through the payment provider.

Account creation may be a conventional user account or a “fast pay” account. The conventional account requires to the user provide specific information, such as a credit card number, a bank account number, and/or a social security number. The user may be hesitant to provide this type of information, which may result in the user deciding not to create an account with the payment provider, and thus not making the purchase with the merchant. Reasons may include concerns with providing sensitive information over the system or at the current time (such as if the user is in a public place where others may be able to see the information) or time required to locate and provide this information, especially if the user is in a hurry.

In one embodiment, the payment provider may create an account for the user with less information than required for a conventional full account. When the user is ready to make a payment from a merchant site, the user may select an option for payment using the services of the payment provider. The user may be shown a screen to sign up and pay using the payment provider. The screen may include requested information, such as name, address, phone number, date of birth, email, and creation of a password in one embodiment. In other embodiments, not all this information may be required or other information added/substituted. No credit card, bank account, or other financial/funding source information is required here.

Using this information, the payment provider may create an account and provide the credit for the user to pay for the transaction. The payment provider may analyze credit-worthiness of the user from the information, such as through Bill Me Later, internal databases and tools, and publicly available information. A key component for deciding whether to create the account and authorize payment is the amount of the request from step 202. For example, a small amount, say $50 or less, is much more likely to be approved than a large amount, such as $1000 or over. The lesser amount exposes the payment provider to a much lower risk. If the request cannot be approved, a user account may still be opened based on the information. The user may then be asked to provide information for a funding source to proceed. Otherwise, the payment provider may retain the information and request the user to provide additional information at a later time to complete a full account opening. In one embodiment, such a fast pay account may be used only once, in that the user will be required to enter a funding source for a subsequent payment request through the payment provider. However, in another embodiment, the payment provider may allow the user to make payments through fast pay more than once before requiring funding source information to be added.

Once a new account is created for the user, the payment provider processes the payment request at step 210. For a conventional account, the payment provider may debit a funding source of the user and credit an account of the merchant. Notification may be sent to the user and/or the merchant that the payment has been made. For a fast pay account, the payment provider may extend credit to the user on behalf of the payment provider (such as debiting an account of the payment provider) and credit an account of the merchant. A notification may be send to the user and/or the merchant that the payment was successful. The user may also receive a message, at the same time or later, to submit payment to the payment provider, such as sending in a check or providing funding source information so that the payment provider can withdraw funds from the funding source. Funding source information may include a credit card number and expiration date or a bank account number and routing number.

Referring back to step 206, if the payment provider determines that the user has an active account with the payment provider, the payment provider may present default payment options to the user at step 208, based on information from the user's account. Default options, such as discussed above, may include payment though a user account with the payment provider, funding by a specific credit card or bank account, payment through a user account with the merchant, or payment directly through a credit card. Other options may also be present, such as timing of payment(s), any installment schedules, etc.

Included in the display to the user may be an option to change one or more payment options. For example, the display may include a button, link, or field indicating to use the current default payment options and another button, link, or field indicating the users wish to change one or more of the displayed or default payment options. If the user does not wish to change the default payment options, as determined at step 214, the user may select the appropriate button, link, or field, and transmits that information to the payment provider. The payment provider may then process the payment request based on the default payment options.

However, if the user does want to change one or more of the default payment options, the user may select the appropriate button, link, or field, and transmits information to the payment provider. Once the payment provider receives an indication that the user wants to change one or more payment options, the payment provider may determine available options for change and present those options to the user at step 216. This may be done in any suitable manner. For example, the user may be shown a list of payment options, where details for each payment option is shown when the user selects that option or hovers over the options. The presented options may be all payment options or only payment options available to the user and to the particular transaction. For the latter, the payment provider may determine conditions of the current payment options and the user's account information to see which payment options would be available to the user. For example, the purchase and/or the user may not qualify for certain payment options, such as a specific deferred payment or installment plan and therefore not presented.

For example, a user may be given the option of automatically paying with a specific funding source after the purchase has been delivered. The user may be presented with details, such as the amount, the funding source (e.g., Visa with last four digits or Citibank with last four digits), timing of payment (e.g., 14 days after purchase), and other details, such as the payment will be automatically withdrawn from the funding source on the specified date.

After payment options are presented to the user, the user makes any desired changes to the payment options. For example, the user may choose a different funding source because the previously funding source is near its limit, the user wants to use a different funding source to accumulate points for a particular purpose, and/or the different funding source is offering incentives for its use. Changes may be made by the user through the user device and changes transmitted by the user device to a server or other device of the payment provider. The use may select an offered option, such as by selecting from a drop down menu, checking a box, or other means of selection. The user may also revise fields if applicable. For example, the user may wish to change the installment period, the installment amount, make an immediate partial payment, etc. After the user makes the desired changes, those changes are received by the payment provider at step 218.

The payment provider then determines, at step 220, whether the received changes are acceptable. This step may be skipped if the options presented to the user at step 216 were already determined by the payment provider to be acceptable for the user and the transaction. However, if that was not the case, the payment provider determines if the user changes are allowed. This may include determining whether there are any restrictions on the user's account and details of the transaction, including the amount, terms of the purchase, the merchant, date of purchase, and initial payment option(s). If the selected payment options are allowed, the payment provider processes the payment request, at step 210, with the revised payment options, which may include one or more default options not changed. Processing may include debiting one or more funding sources of the user at appropriate times and crediting an account of the merchant. Notification may be sent to the user and/or the merchant that the payment has been made.

If one or more user-submitted changes are not allowed or acceptable (e.g., cannot be processed or approved by the payment provider), the user may be allowed to make any needed corrections. For example, the user may be informed that one or more specific changes were unacceptable and the reasons the change(s) were not acceptable. The user may be presented with payment options again and given the opportunity to re-select or re-enter changes, which are received at step 218.

The user may also be taken back to step 212 and shown the originally selected default payment options. The user can then decide whether to keep the default payment options in light of the rejection of one or more revised payment options or make changes, which are received and processed by the payment provider as previously discussed. Once the payment provider has approved of any and all changes, the payment is processed at step 210.

FIG. 2B is a flowchart showing one embodiment of a process 250 a payment provider performs to process a change to a previously approved payment request after the purchase has been made. The change can occur at any time after the initial purchase is made, e.g., after checkout. However, there is a time when the user can no longer make changes. That time period will depend on various factors, including conditions of the purchase, time of the purchase, payment terms, available payment option changes, user account restrictions or limitations, and/or payment provider rules.

At step 252, the payment provider receives user information, which may include a user identifier, such as a name, email address, phone number, or user name, and a login/access credential, such as a PIN or password. The information may be received through a user device, such as a smart phone, PC, tablet, or other computing device. The information may be entered by the user and/or automatically provided through the device when communicating with the payment provider, such as through an API call or browser.

The payment provider then accesses the user's account at step 254 using the received user information. An account database may be searched to determine whether an account exists associated with the user information, and if so, whether the account is active. Assuming a valid account is located, the payment provider may access details of the account including any current payment transactions for the user, such as payment transactions that have not been completely fulfilled or are pending at some level. One example of this would be a user making a payment through the payment provider, where the payment provider has fully paid the merchant or payee on behalf of the user, but the user has not fully paid the payment provider.

Once accessed, the payment provider receives a change request from the user at step 256. The change request may include an indication that the user desires to change one or more payment options previously selected, followed by a presentation to the user on the user device of possible payment options, and information about what option(s) to change and how. This may be similar to steps 214, 216, and 218 described above.

After receiving the change request, the payment provider may access the particular transaction at step 258. The user may have selected the transaction from a list of pending or available transactions and communicating this information to the payment provider. For example, the user may be presented with a list of pending or available transactions from which the user can select from. The user may select the desired transaction by checking a box, selecting a link or button, or other suitable means. Note that steps 254-258 may be performed in different sequences or combined partially or completely in a single step.

At step 260, the payment provider determines whether the received change request can be allowed or accepted. For example, if one payment option is a deferred payment of 30 days, but a current default payment is a 60 day deferral period and 30 days has already passed from the time of purchase, the 30 day deferral period option would not be possible and therefore rejected. In another example, the user may have restrictions on the user's account that prevents him from using a certain payment option for the transaction. Thus, account rules and payment provider rules may restrict what the user is allowed to use as different payment options after the transaction.

If the user-requested changes are not allowed, a determination is made, at step 262, whether the user can try again. Risk and other system rules may factor in this determination. For example, a user may only be allowed one attempt if the payment provider determines that there is a likelihood of fraudulent activity with the process or that this option only permits one user attempt. If the user is not allowed a retry, the process ends, and the payment options remain unchanged.

If the user is allowed to retry, the payment provider may provide reasons to the user why the received change request was not allowed, including specific reasons for specific payment option changes. Allowed payment option changes, if the user submitted multiple changes, may be shown as well. The user may then make the desired changes from the user device and transmit those changes to the payment provider, who receives the changes at step 264. A determination is then made at step 260 whether the newly received changes are allowable.

Once received changes are allowable, the changes are processed at step 266, where processing may include debiting one or more funding sources of the user at appropriate times. Notification may be sent to the user that the payment changes have been accepted.

Thus, a purchase may be decoupled from a payment in that one or more payment options can be changed after a payment request has been completed with one or more different options and funding sources no longer need to be tied into conventional terms or conditions. For example, a user may complete a purchase with one set of payment options (funding sources, terms, settlement, etc.) and then change one or more options after the payment has already been made to the merchant. A payment request processed by a payment provider may be made even without the user having had opened an account previously and without the user having to submit funding source information to the payment provider.

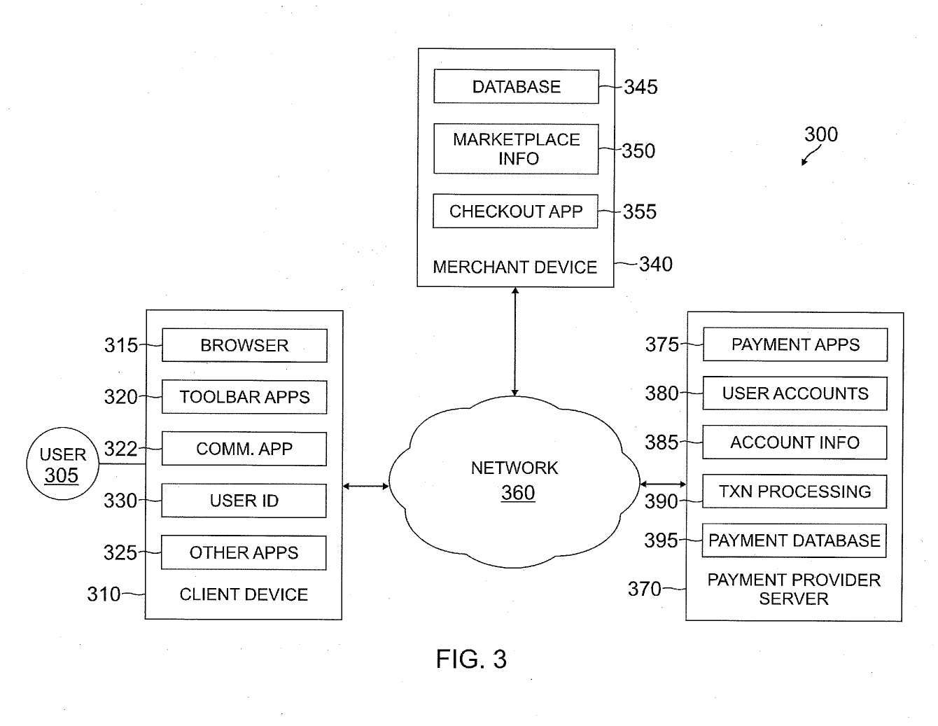

FIG. 3 is a block diagram of a networked system 300 configured to process a financial transaction between a payment recipient (e.g., merchant) and a payment sender (e.g., user or consumer), such as described above, in accordance with an embodiment of the invention. System 300 includes a user device 310, a merchant server 340, and a payment provider server 370 in communication over a network 360. Payment provider server 370 may be maintained by a payment provider, such as PayPal, Inc. of San Jose, Calif. A user 305, such as the sender or consumer, utilizes user device 310 to perform a payment transaction with merchant server 340 using payment provider server 370 or to convey a desire to make a payment through the payment provider so that the payment provider may provide different payment options during or after a checkout with the merchant.

User device 310, merchant server 340, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web or mobile browser configured to view information available over the Internet. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to communicate, place orders, make payments, and change payment options through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300.

Merchant server 340 may be maintained, for example, by a merchant or seller offering various products and/or services in exchange for payment to be received over network 360. Generally, merchant server 340 may be maintained by anyone or any entity that receives money, which includes charities as well as retailers and restaurants. Merchant server 340 includes a database 345 identifying available products and/or services (e.g., collectively referred to as items) which may be made available for viewing and purchase by user 305, including receipts associated with identifiers, such as barcodes. Accordingly, merchant server 340 also includes a marketplace application 350 which may be configured to serve information over network 360 to browser 315 of user device 310. In one embodiment, user 305 may interact with marketplace application 350 through browser applications over network 360 in order to view various products, food items, or services identified in database 345.

Merchant server 340 also includes a checkout application 355 which may be configured to facilitate the purchase by user 305 of goods or services identified by marketplace application 350. Checkout application 355 may be configured to accept payment information from or on behalf of user 305 through payment service provider server 370 over network 360. For example, checkout application 355 may receive and process a payment confirmation or payment options from payment service provider server 370, as well as transmit transaction information to the payment provider and receive information from the payment provider. Checkout application 355 may also be configured to accept one or more different funding sources and/or other payment options for payment, as well as create an invoice or receipt of the transaction.

Payment provider server 370 may be maintained, for example, by an online payment service provider which may provide payment between user 305 and the operator of merchant server 340. In this regard, payment provider server 370 includes one or more payment applications 375 which may be configured to interact with user device 310 and/or merchant server 340 over network 360 to facilitate the purchase of goods or services by user 305 of first user device 310 at a merchant POS or site as discussed above.

Payment provider server 370 also maintains a plurality of user accounts 380, each of which may include account information 385 associated with individual users. For example, account information 385 may include private financial information of users of devices such as account numbers, passwords, device identifiers, user names, phone numbers, credit card information, bank information, or other financial information which may be used to facilitate online transactions by user 305. Advantageously, payment application 375 may be configured to interact with merchant server 340 on behalf of user 305 during a transaction with checkout application 355 to track and manage purchases made by users and which funding sources are used.

A transaction processing application 390, which may be part of payment application 375 or separate, may be configured to receive information from a user device and/or merchant server 340 for processing and storage in a payment database 395. Transaction processing application 390 may include one or more applications to process information from user 305 for processing an order and payment at a merchant POS as described herein. As such, transaction processing application 390 may store details of an order associated with a fast pay authorization or account for individual users as well as track pending payment transactions in which the user may change one or more payment options. Payment application 375 may be further configured to determine the existence of and to manage accounts for user 305, as well as create new accounts if necessary, such as a fast pay account.

Payment database 395 may store transaction details from completed transactions, including pre-authorization details and/or details of the transaction. Such information may also be stored in a third party database accessible by the payment provider and/or the merchant.

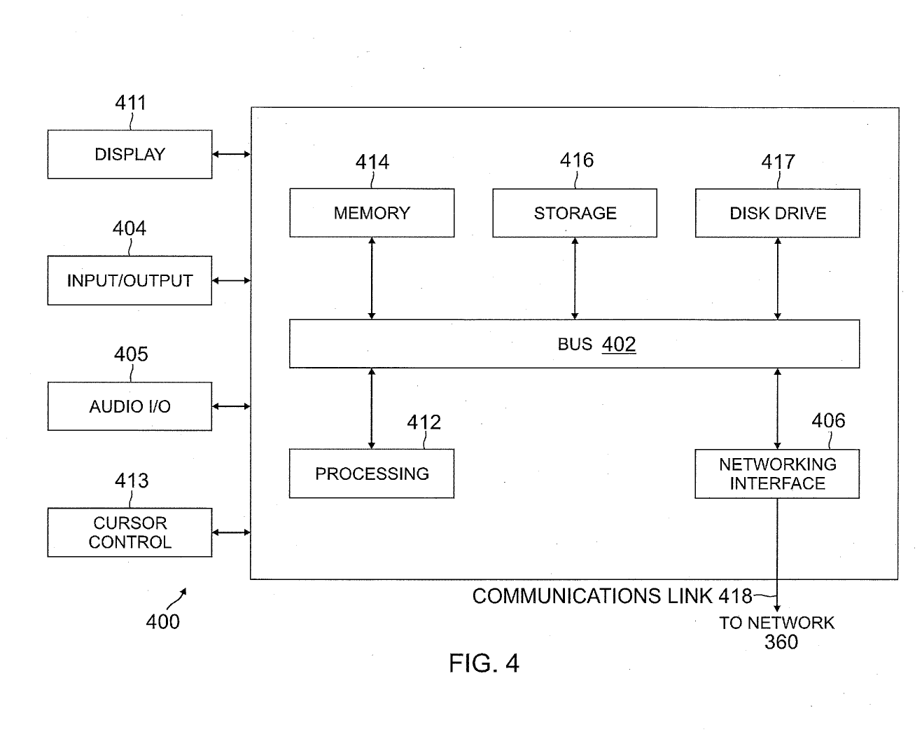

FIG. 4 is a block diagram of a computer system 400 suitable for implementing one or more embodiments of the present disclosure. In various implementations, the user device may comprise a personal computing device (e.g., a personal computer, laptop, smart phone, tablet, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
receiving, by a processor of a payment provider, information about a user from a user device;
accessing an account of the user with the payment provider if an account exists for the user;
receiving, by the processor, a request from the user to change one or more payment options previously selected by the user for a payment transaction with a merchant and after the payment transaction has been completed with the merchant by the payment provider using the previously selected payment options; and
processing the request if the request is allowed as determined by the processor of the payment provider.

2. The method of claim 1, wherein the one more payment options comprises one or more funding sources or one or more payment terms.

3. The method of claim 1, wherein the one or more payment options comprises a funding source, an installment term, or a deferred payment period.

4. The method of claim 1, further comprising opening an account for the user if no account exists for the user with the payment provider without requiring the user to provide information about a funding source.

5. The method of claim 1, further comprising opening an account for the user if no account exists for the user with the payment provider without requiring the user to provide a social security number of the user.

6. The method of claim 1, further comprising providing available payment options to change to the user prior to receiving the request.

7. The method of claim 6, wherein the available payment options is based on at least the payment transaction and the account of the user.

8. The method of claim 7, wherein the available payment options is further based on a date the request is received.

9. The method of claim 1, wherein the information comprises a user identifier and a user login credential.

10. The method of claim 1, wherein the merchant has been paid in full for the payment transaction through the payment provider prior to receiving the request.

11. A system, comprising:
a computer storage storing account information for a plurality of users having an account with a payment provider, wherein the account information comprises payment transactions between a user and a merchant, wherein the payment provider has made a payment to the merchant on behalf of the user for a payment transaction; and
a processor operable to:
receive information about a user from a user device;
access an account of the user with the payment provider if an account exists for the user;
receive a request from the user to change one or more payment options previously selected by the user for the payment transaction with the merchant and after the payment transaction has been completed with the merchant by the payment provider using the previously selected payment options; and
process the request if the request is allowed as determined by the payment provider.

12. The system of claim 11, wherein the one more payment options comprises one or more funding sources and/or one or more payment terms.

13. The system of claim 11, wherein the one or more payment options comprises a funding source, an installment term, or a deferred payment period.

14. The system of claim 11, wherein the processor is further operable to open an account for the user if no account exists for the user with the payment provider without requiring the user to provide information about a funding source.

15. The system of claim 11, wherein the processor is further operable to open an account for the user if no account exists for the user with the payment provider without requiring the user to provide a social security number of the user.

16. The system of claim 11, wherein the processor is further operable to provide available payment options to change to the user prior to receiving the request.

17. The system of claim 11, wherein the available payment options is based on at least the payment transaction, the account of the user, and a date the request is received.

18. The system of claim 11, wherein the merchant has been paid in full for the payment transaction through the payment provider prior to receiving the request.

19. A non-transitory machine-readable medium comprising a plurality of machine-readable instructions which when executed by one or more processors of a server are adapted to cause the server to perform a method comprising:
receiving, by a payment provider, information about a user from a user device;
accessing an account of the user with the payment provider if an account exists for the user;
receiving a request from the user to change one or more payment options previously selected by the user for a payment transaction with a merchant and after the payment transaction has been completed with the merchant by the payment provider using the previously selected payment options; and
processing the request if the request is allowed as determined by the payment provider.

20. The non-transitory machine-readable medium, wherein the method further comprises opening an account for the user if no account exists for the user with the payment provider without requiring the user to provide information about a funding source.
